(19) United States
(12) Patent Application Publication
(10) Pub. No.: US 2015/0172814 A1
(43) Pub. Date: Jun. 18, 2015

(54) METHOD AND SYSTEM FOR DIRECTIONAL ENHANCEMENT OF SOUND USING SMALL MICROPHONE ARRAYS

(71) Applicant: Personics Holdings, Inc., Boca Raton, FL (US)

(72) Inventors: John Usher, Beer (GB); Steve Goldstein, Delray Beach, FL (US)

(73) Assignee: Personics Holdings, Inc., Boca Raton, FL (US)

(21) Appl. No.: 14/108,883

(22) Filed: Dec. 17, 2013

(51) Int. Cl. H04R 3/00

(52) U.S. Cl. CPC H04R 3/005

(57) ABSTRACT

Herein provided is a method and system for directional enhancement of a microphone array comprising at least two microphones by analysis of the phase angle of the coherence between at least two microphones. The method can further include communicating directional data with the microphone signal to a secondary device, and adjusting at least one parameter of the device in view of the directional data. Other embodiments are disclosed.

### FIELD

The present invention relates to audio enhancement in noisy environments with particular application to mobile audio devices such as augmented reality displays, mobile computing devices, headphones, hearing aids.

### BACKGROUND

Increasing the signal to noise ratio (SNR) of audio systems is generally motivating by a desire to increase the speech intelligibility in a noisy environment, for purposes of voice communications and machine-control via automatic speech recognition.

A common system to increase SNR is using directional enhancement systems, such as the “beam-forming” systems. Beamforming or “spatial filtering” is a signal processing technique used in sensor arrays for directional signal transmission or reception. This is achieved by combining elements in a phased array in such a way that signals at particular angles experience constructive interference while others experience destructive interference.

The improvement compared with omnidirectional reception is known as the receive gain. For beamforming applications with multiple microphones, the receive gain, measured as an improvement in SNR, is about 3 dB for every additional microphone, i.e. 3 dB improvement for 2 microphones, 6 dB for 3 microphones etc. This improvement occurs only at sound frequencies where the wavelength is above the spacing of the microphones.

The beamforming approaches are directed to arrays where the microphones are spaced wide with respect to one another. There is also a need for a method and device for directional enhancement of sound using small microphone arrays.

### BRIEF DESCRIPTION OF THE DRAWINGS

FIG. 1A illustrates an acoustic sensor in accordance with an exemplary embodiment;

FIG. 1B illustrates a wearable system for directional enhancement of sound in accordance with an exemplary embodiment;

FIG. 1C illustrates another wearable system for directional enhancement of sound in accordance with an exemplary embodiment;

FIG. 1D illustrates a mobile device for coupling with the wearable system in accordance with an exemplary embodiment;

FIG. 1E illustrates another mobile device for coupling with the wearable system in accordance with an exemplary embodiment;

FIG. 2 is method for updating directional enhancement filter.

FIG. 3 is a measurement setup for acquiring target inter-microphone coherence between omni-directional microphones M1 and M2 for sound targets at particular angles of incidence (i.e. angle theta) in accordance with an exemplary embodiment;

FIG. 4A-4F shows analysis of coherence from measurement set-up in FIG. 3 with different target directions showing imaginary, real, and (unwrapped) phase angle in accordance with an exemplary embodiment;

FIG. 5 shows a multi-microphone configuration and control interface to select desired target direction and output source location in accordance with an exemplary embodiment;

FIG. 6 depicts a method for determining source location from analysis of measured coherence angle in accordance with an exemplary embodiment;

FIG. 7 is an exemplary earpiece for use with the coherence based directional enhancement system of FIG. 1A in accordance with an exemplary embodiment;

FIG. 8 is an exemplary mobile device for use with the coherence based directional enhancement system in accordance with an exemplary embodiment; and

FIG. 9 depicts a method for social deployment of directional enhancement of acoustic signals within social media in accordance with an exemplary embodiment.

### DETAILED DESCRIPTION

The following description of at least one exemplary embodiment is merely illustrative in nature and is in no way intended to limit the invention, its application, or uses. Similar reference numerals and letters refer to similar items in the following figures, and thus once an item is defined in one figure, it may not be discussed for following figures.

Herein provided is a method and system for affecting the directional sensitivity of a microphone array system comprised of at least two microphones, for example, such as those mounted on a headset or small mobile computing device. It overcomes the limitations experienced with conventional beamforming approaches using small microphone arrays. Briefly, in order for a useful improvement in SNR, there must be many microphones (e.g. 3-6) spaced over a large volume (e.g. for SNR enhancement at 500 Hz, the inter-microphone spacing must be over half a meter).

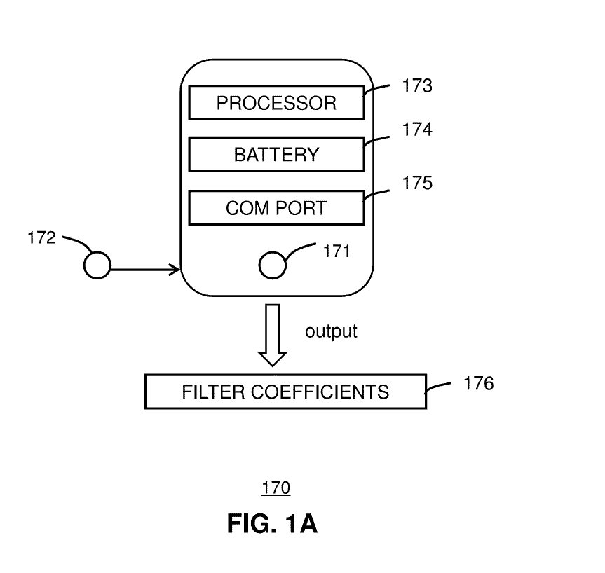

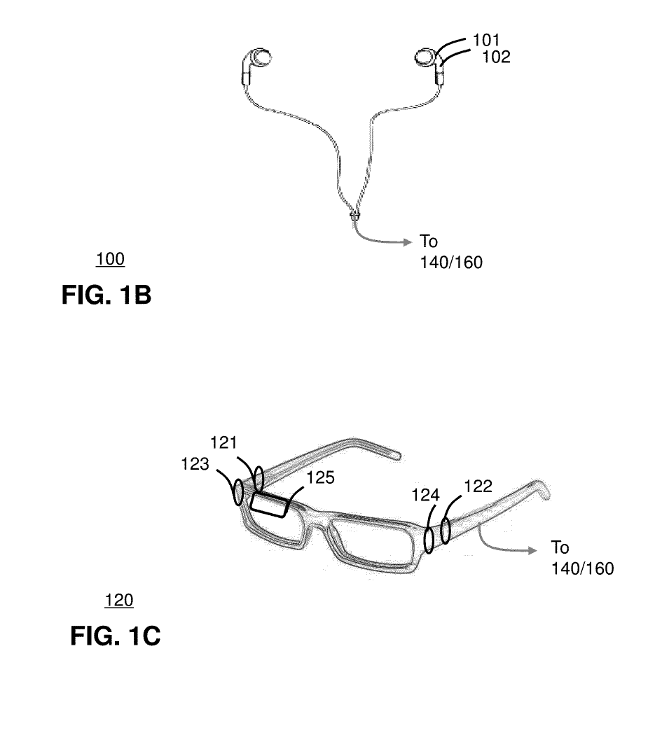

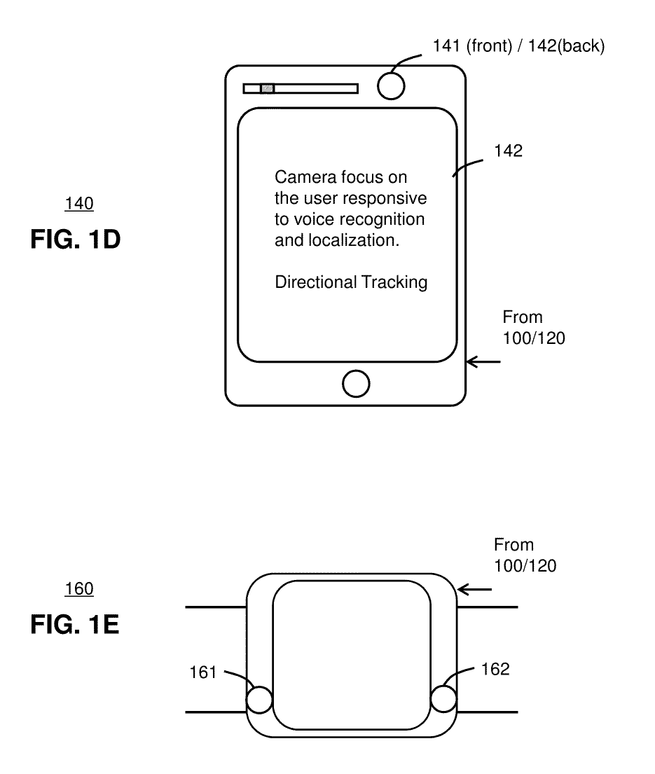

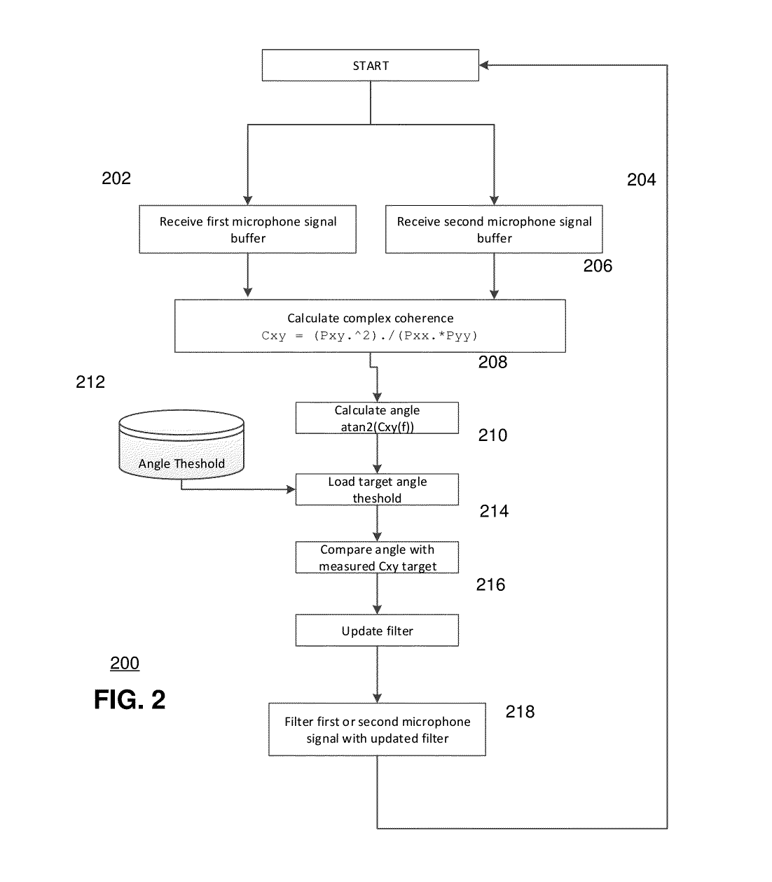

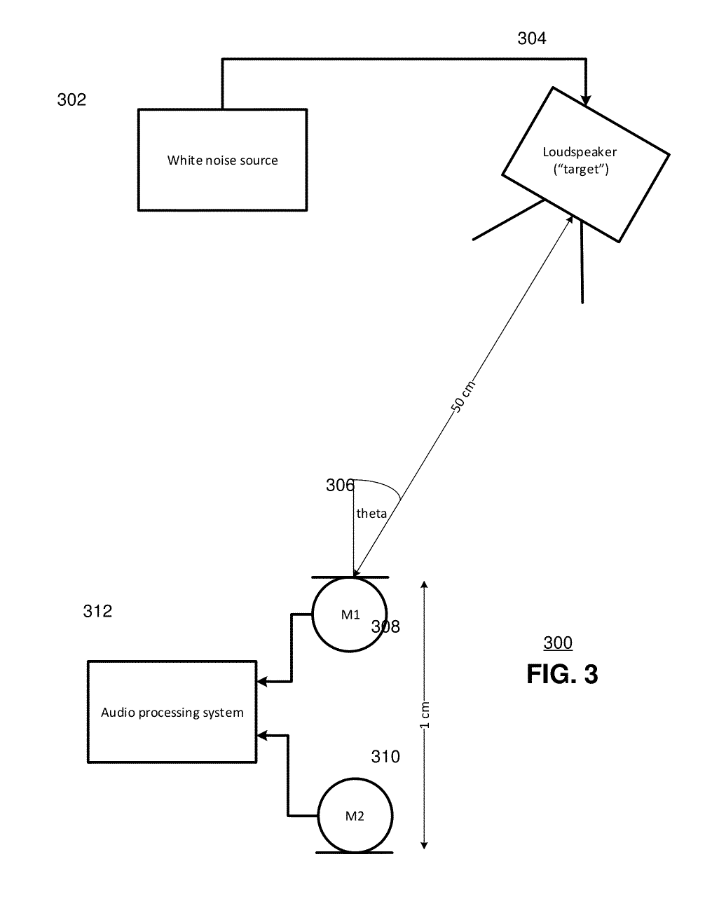

FIG. 1A depicts an acoustic device 170 to increase a directional sensitivity of a microphone signal. As will be shown ahead in FIGS. 1B-1E the components therein, can be integrated and/or incorporated into the wearable devices (e.g., headset 100, eyeglasses 120, mobile device 140, wrist watch 160, earpiece 500). The acoustic device 170 includes a first microphone 171, and a processor 171 for receiving a first microphone signal from the first microphone 171. It also receives a second microphone signal from a second microphone 172. This second microphone 172 may be part of the device housing the acoustic device 170 or a separate device, and which is communicatively coupled to the acoustic device 170. For example, the second microphone 172 can be communicatively coupled to the processor 173 and reside on a secondary device that is one of a mobile device, a phone, an earpiece, a tablet, a laptop, a camera, a web cam, a wearable accessory, smart eyewear, or smart headwear.

In another arrangement the acoustic device 170 can also be coupled to, or integrated with non-wearable devices, for example, with security cameras, buildings, vehicles, or other stationary objects. The acoustic device 170 can listen and localize sounds in conjunction with the directional enhancement methods herein described and report acoustic activity, including event detections, to other communicatively coupled devices or systems, for example, through wireless means (e.g. wi-fi, Bluetooth, etc) and networks (e.g., cellular, wi-fi, internet, etc.). As one example, the acoustic device 170 can be communicatively coupled or integrated with a dash cam for police matters, for example, wirelessly connected to microphones within officer automobiles and/or on officer glasses, headgear, mobile device and other wearable communication equipment external to the automobile.

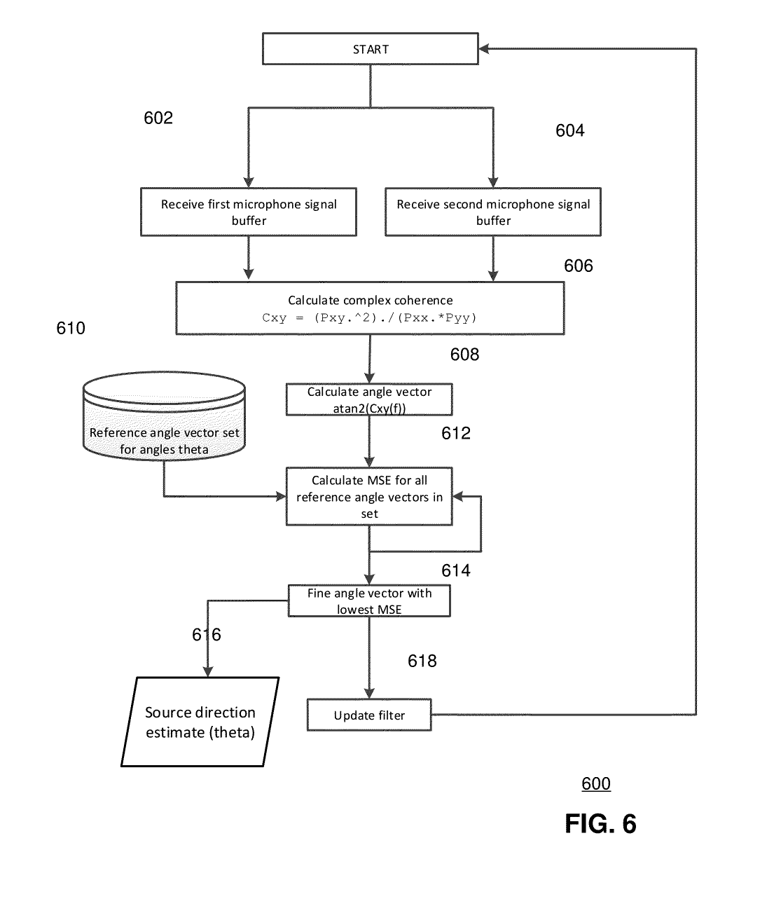

It should also be noted that the acoustic device 170 can also be coupled to other devices, for example, a security camera, for instance, to pan and focus on directional or localized sounds. Additional features and elements can be included with the acoustic device 170, for instance, communication port 175, also shown ahead in FIG. 6, to include communication functionality (wireless chip set, Bluetooth, Wi-Fi) to transmit the localization data and enhanced acoustic sound signals to other devices. In such a configuration, other devices in proximity or communicatively coupled can receive enhanced audio and directional data, for example, on request, responsive to an acoustic event (e.g., sound signature detection), a recognized voice (e.g., speech recognition), or combination thereof, for instance GPS localization information and voice recognition.

As will be described ahead, the method implemented by way of the processor 173 performs the steps of calculating a complex coherence between the first and second microphone signal, determining a measured frequency dependent phase angle of the complex coherence, comparing the measured frequency dependent phase angle with a reference phase angle threshold and determining if the measured frequency dependent phase angle exceeds a predetermined threshold from the reference phase angle, outputting/updating a set of frequency dependent filter coefficients 176 based on the comparing to produce an updated filter coefficient set, and filtering the first microphone signal or the second microphone signal with the updated filter coefficient set 176 to enhance a directional sensitivity and quality of the microphone signal, from either or both microphones 171 and 172. The devices to which the output signal is directed can include at least one of the following: loudspeaker, haptic feedback, telecommunications device, audio recording system and automatic speech recognition system. In another arrangement, the sound signals (e.g., voice, ambient sounds, external sounds, media) of individual users of wiki talkie systems can be enhanced in accordance with the user's direction or location with respect to other users. For instance, another users voice can be enhanced based on their directionality. The improved quality acoustic signal can also be fed to another system, for example, a television for remote operation to perform a voice controlled action. In other arrangements, the voice signal can be directed to a remote control of the TV which may process the voice commands and direct a user input command, for example, to change a channel or make a selection. Similarly, the voice signal or the interpreted voice commands can be sent to any of the devices communicatively controlling the TV.

The processor 173 can further communicate directional data derived from the coherence based processing method with the microphone signal to the secondary device, where the directional data includes at least a direction of a sound source, and adjusts at least one parameter of the device in view of the directional data. For instance, the processor can focus or pan a camera of the secondary device to the sound source as will be described ahead in specific embodiments. For example, the processor can perform an image stabilization and maintain a focused centering of the camera responsive to movement of the secondary device, and, if more than one camera is present and communicatively coupled thereto, selectively switch between one or more cameras of the secondary device responsive to detecting from the directional data whether a sound source is in view of the one or more cameras.

In another arrangement, the processor 173 can track a direction of a voice identified in the sound source, and from the tracking, adjusting a display parameter of the secondary device to visually follow the sound source. In another example, as explained ahead, a signal can be presented to a user wearing the eyewear indicating where a sound source is arriving from and provide a visual display conveying that location. The signal can be prioritized, for example, by color, text features (size, font, color, etc), for instance, to indicate a sound is experienced out of the peripheral range of the user (viewer). For example, responsive to the eyewear detecting a voice recognized talker behind the wearer of the eyeglasses, the visual display presents the name of the background person speaking, to visually inform the wearer of who the person is, and where they are standing in their proximity (e.g., location). The eyeglasses may even provide additional information on the display based on the recognition of the person in the vicinity, for example, an event (e.g., birthday, meeting) to assist the wearer in conversational matters with that person.

Referring to FIG. 1B, a system 100 in accordance with a headset configuration is shown. In this embodiment, wherein the headset operates as a wearable computing device, the system 100 includes a first microphone 101 for capturing a first microphone signal, a second microphone 102 for capturing a second microphone signal, and a processor 140/160 communicatively coupled to the first microphone 101 and the second microphone 102 to perform a coherence analysis, calculate a coherence phase angle, and generate a set of filter coefficients to to increase a directional sensitivity of a microphone signal is shown. As will be explained ahead, the processor 140/160 may reside on a communicatively coupled mobile device or other wearable computing device. Aspects of signal processing performed by the processor may be performed by one or more processors residing in separate devices communicatively coupled to one another. At least one of the microphones are processed with an adaptive filter, where the filter is adaptive so that sound from one direction is passed through and sounds from other directions are blocked, with the resulting signal directed to, for instance, a loudspeaker or sound analysis system such as an Automatic Speech Recognition (ASR) system.

During the directional enhancement processing of the captured sound signals, other features are also selectively extracted, for example, spectral components (e.g., magnitude, phase, onsets, decay, SNR ratios) some of which are specific to the voice and others related to attributable characteristic components of external acoustic sounds, for example, wind or noise related features. These features are segregated by the directional enhancement and can be input to sound recognition systems to determine what type of other sounds are present (e.g., sirens, wind, rain, etc.). In such an arrangement, feature extraction for sound recognition, in addition to voice, is performed in conjunction with directional speech enhancement to identify sounds and sound directions and apply an importance weighting based on the environment context, for example, where is the user (e.g, GPS, navigation) and in proximity to what services (e.g, businesses, restaurants, police, games etc.) and other people (e.g., ad-hoc users, wi-fi users, internet browers, etc.)

The system 100 can be configured to be part of any suitable media or computing device. For example, the system may be housed in the computing device or may be coupled to the computing device. The computing device may include, without being limited to wearable and/or body-borne (also referred to herein as bearable) computing devices. Examples of wearable/body-borne computing devices include head-mounted displays, earpieces, smart watches, smartphones, cochlear implants and artificial eyes. Briefly, wearable computing devices relate to devices that may be worn on the body. Bearable computing devices relate to devices that may be worn on the body or in the body, such as implantable devices. Bearable computing devices may be configured to be temporarily or permanently installed in the body. Wearable devices may be worn, for example, on or in clothing, watches, glasses, shoes, as well as any other suitable accessory.

The system 100 can also be deployed for use in non-wearable contexts, for example, within cars equipped to take photos, that with the directional sound information captured herein and with location data, can track and identify where the car is, the occupants in the car, and the acoustic sounds from conversations in the vehicle, and interpreting what they are saying or intending, and in certain cases, predicting a destination. Consider photo equipped vehicles enabled with the acoustic device 170 to direct the camera to take photos at specific directions of the sound field, and secondly, to process and analyze the acoustic content for information and data mining. The acoustic device 170 can inform the camera where to pan and focus, and enhance audio emanating from a certain pre-specified direction, for example, to selectively only focus on male talkers, female talkers, or non-speech sounds such as noises or vehicle sounds.

Although only the first 101 and second 102 microphone are shown together on a right earpiece, the system 100 can also be configured for individual earpieces (left or right) or include an additional pair of microphones on a second earpiece in addition to the first earpiece. The system 100 can be configured to be optimized for different microphone spacing's.

Referring to FIG. 1C, the system 100 in accordance with yet another wearable computing device is shown. In this embodiment, eyeglasses 120 operate as the wearable computing device, for collective processing of acoustic signals (e.g., ambient, environmental, voice, etc.) and media (e.g., accessory earpiece connected to eyeglasses for listening) when communicatively coupled to a media device (e.g., mobile device, cell phone, etc.). In this arrangement, analogous to an earpiece with microphones but rather embedded in eyeglasses, the user may rely on the eyeglasses for voice communication and external sound capture instead of requiring the user to hold the media device in a typical hand-held phone orientation (i.e., cell phone microphone to mouth area, and speaker output to the ears). That is, the eyeglasses sense and pick up the user's voice (and other external sounds) for permitting voice processing. An earpiece may also be attached to the eyeglasses 120 for providing audio and voice.

In the configuration shown, the first 121 and second 122 microphones are mechanically mounted to one side of eyeglasses. Again, the embodiment 120 can be configured for individual sides (left or right) or include an additional pair of microphones on a second side in addition to the first side. The eyeglasses 120 can include one or more optical elements, for example, cameras 123 and 124 situated at the front or other direction for taking pictures. Using the first microphone 121 and second microphone 122 to analysis the phase angle of the inter-microphone coherence allows for directional sensitivity to be tuned for any angle in the horizontal plane. Similarly, a processor 140/160 communicatively coupled to the first microphone 121 and the second microphone 122 for analyzing phase coherence and updating the adaptive filter may be present.

As noted above, the eyeglasses 120 may be worn by a user to enhance a directional component of a captured microphone signal to enhance the voice quality. The eyeglasses 120 upon detecting another person speaking can perform the method steps contemplated herein for enhancing that users voice arriving from a particular direction. This enhanced voice signal, that of the secondary talker, or the primary talker wearing the eyeglasses, can then be directed to an automatic speech recognition system (ASR). Directional data can also be supplied to the ASR for providing supplemental information needed to parse or recognize words, phrases or sentences. Moreover, the directional component to the sound source, which is produced as a residual component of the coherence based method of directional speech enhancement, can be used to adjust a device configuration, for example, to pan a camera or adjust a focus on the sound source of interest. As one example, upon the eyeglasses 120 recognizing a voice of a secondary talker that is not in view of the glasses, the eyeglasses can direct the camera 123/124 to focus on that user, and present a visual of that user in the display 125 of the eyeglasses 120. Although the secondary view may not be in the view field of the primary talker wearing the glasses, the primary user is now visually informed of the presence of the secondary talker that has been identified through speech recognition that is in acoustic proximity to the wearer of the eyeglasses 120.

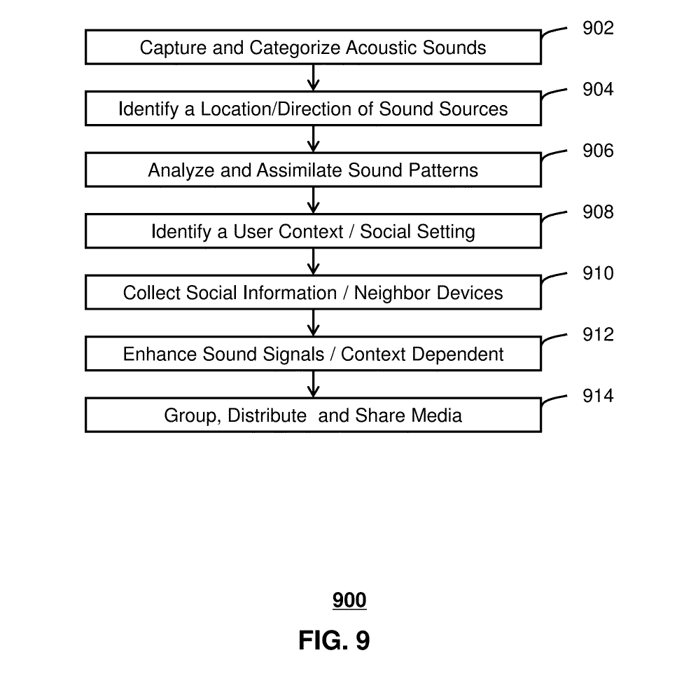

FIG. 1D depicts a first media device 140 as a mobile device (i.e., smartphone) which can be communicatively coupled to either or both of the wearable computing devices (100/120). FIG. 1E depicts a second media device 140 as a wristwatch device which also can be communicatively coupled to the one or more wearable computing devices (100/120). As previously noted in the description of these previous figures, the processor performing the coherence analysis for updating the adaptive filter is included thereon, for example, within a digital signal processor or other software programmable device within, or coupled to, the media device 140 or 160. As will be discussed ahead and in conjunction with FIG. 9B, components of the media device for implementing coherence analysis functionality will be explained in further detail.

As noted above, the mobile device 140 may be handled by a user to enhance a directional component of a captured microphone signal to enhance the voice quality. The mobile device 140 upon detecting another person speaking can perform the method steps contemplated herein for enhancing that users voice arriving from a separate direction. Upon detection, the mobile device 140 can adjust one or more component operating parameters, for instance, focusing or panning a camera toward the detected secondary talker. For example, a back camera element 142 on the mobile device 140 can visually track a secondary talker within acoustic vicinity of the mobile device 140. Alternatively, a front camera element 141 can visually track a secondary talker that may be in vicinity of the primary talker holding the phone. Among other applications, this allows the person to visually track others behind him or her that may not be in direct view. The mobile device 140 embodying the directional enhancement methods contemplated herein can also selectively switch between cameras, for example, deciding whether the mobile device is laying on a table, by which, the camera element on that side would be temporarily disabled. Although such methods may be performed by image processing the method of directional enhancement herein is useful in dark (e.g., nighttime) conditions where a camera may not be able to localize its direction.

As another example, the mobile device by way of the processor can track a direction of a voice identified in the sound source, and from the tracking, adjusting a display parameter of the secondary device to visually follow the sound source. The directional tracking can also be used on the person directly handling the device. For instance, in an application where a camera element 141 on the mobile device 140 captures images or video of the person handling the device, the acoustic device microphone array in conjunction with the processing capabilities, either on an integrated circuit within the mobile device or through an internet connection to the mobile device 140, detects a directional component of the user's voice, effectively localizing the user with respect to the display 142 of the mobile device, and then tracks the user on the display. The tracked user, identified as the sound souce, for example face tracking, can then be communicated to another device (for example, a second phone in a call with the user) to display the person. Moreover, the display would update and center the user on the phone based on the voice directional data. In this manner, the person who is talking is visually followed by the application, for example, a face time application on a mobile device.

With respect to the previous figures, the system 100 may represent a single device or a family of devices configured, for example, in a master-slave or master-master arrangement. Thus, components of the system 100 may be distributed among one or more devices, such as, but not limited to, the media device illustrated in FIG. 1D and the wristwatch in FIG. 1E. That is, the components of the system 100 may be distributed among several devices (such as a smartphone, a smartwatch, an optical head-mounted display, an earpiece, etc.). Furthermore, the devices (for example, those illustrated in FIG. 1B and FIG. 1C) may be coupled together via any suitable connection, for example, to the media device in FIG. 1D and/or the wristwatch in FIG. 1E, such as, without being limited to, a wired connection, a wireless connection or an optical connection.

The computing devices shown in FIGS. 1D and 1E can include any device having some processing capability for performing a desired function, for instance, as shown in FIG. 9B. Computing devices may provide specific functions, such as heart rate monitoring or pedometer capability, to name a few. More advanced computing devices may provide multiple and/or more advanced functions, for instance, to continuously convey heart signals or other continuous biometric data. As an example, advanced “smart” functions and features similar to those provided on smartphones, smartwatches, optical head-mounted displays or helmet-mounted displays can be included therein. Example functions of computing devices may include, without being limited to, capturing images and/or video, displaying images and/or video, presenting audio signals, presenting text messages and/or emails, identifying voice commands from a user, browsing the web, etc.

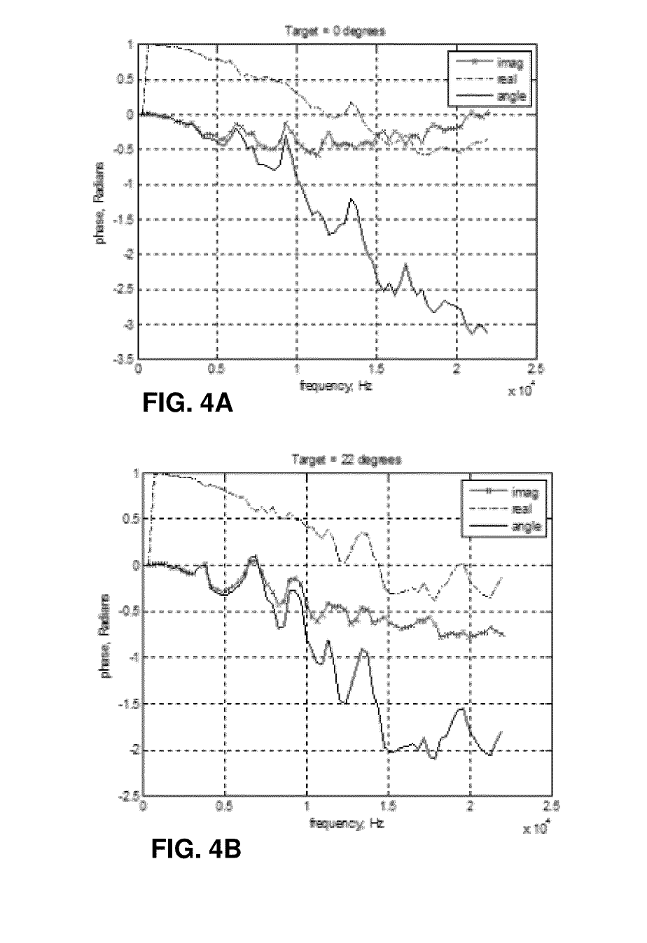

Referring now to FIG. 2, a general method 200 for directional enhancement of audio using analysis of the inter-microphone coherence phase angle is shown. The method 200 may be practiced with more or less than the number of steps shown. When describing the method 200, reference will be made to certain figures for identifying exemplary components that can implement the method steps herein. Moreover, the method 200 can be practiced by the components presented in the figures herein though is not limited to the components shown.

Although the method 200 is described herein as practiced by the components of the earpiece device, the processing steps may be performed by, or shared with, another device, wearable or non-wearable, communicatively coupled, such as the mobile device 140 shown in FIG. 1D, or the wristwatch 160 shown in FIG. 1E. That is, the method 200 is not limited to the devices described herein, but in fact any device providing certain functionality for performing the method steps herein described, for example, by a processor implementing programs to execute one or more computer readable instructions. In the exemplary embodiment describe herein, the earpiece 500 is connected to a voice communication device (e.g. mobile telephone, radio, computer device) and/or audio content delivery device (e.g. portable media player, computer device).

The communication earphone/headset system comprises a sound isolating component for blocking the users ear meatus (e.g. using foam or an expandable balloon); an Ear Canal Receiver (ECR, i.e. loudspeaker) for receiving an audio signal and generating a sound field in a user ear-canal; at least one ambient sound microphone (ASM) for receiving an ambient sound signal and generating at least one ASM signal; and an optional Ear Canal Microphone (ECM) for receiving an ear-canal signal measured in the user's occluded ear-canal and generating an ECM signal. A signal processing system receives an Audio Content (AC) signal (e.g. music or speech audio signal) from the said communication device (e.g. mobile phone etc) or the audio content delivery device (e.g. music player); and further receives the at least one ASM signal and the optional ECM signal. The signal processing system mixes the at least one ASM and AC signal and transmits the resulting mixed signal to the ECR in the loudspeaker.

The first microphone and the second microphone capture a first signal and second signal respectively at step 202 and 204. The order of the capture for which signal arrives first is a function of the sound source location; it not the microphone number; either the first or second microphone may capture the first microphone signal.

At step 206 the system analyzes a coherence between the two microphone signals (M1 and M2). The complex coherence estimate, Cxy as determined in step 206 is a function of the power spectral densities, Pxx(f) and Pyy(f), of x and y, and the cross power spectral density, Pxy(f), of x and y,

$${C}_{xy} ( f ) = \frac{{P}_{xy}^{2}}{{P}_{xx} ( f ) {P}_{yy} ( f )}$$

$${P}_{xy} ( f ) = ( M 1 ) . * conj ( ( M 2 ) )$$

$${P}_{xx} ( f ) = abs ( { ( M 1 )}^{2} )$$

$${P}_{yy} ( f ) = abs ( { ( M 2 )}^{2} )$$

$$where$$

$$= Fourier transform$$

The window length for the power spectral densities and cross power spectral density in the preferred embodiment are approximately 3 ms (˜2 to 5 ms). The time-smoothing for updating the power spectral densities and cross power spectral density in the preferred embodiment is approximately 0.5 seconds (e.g. for the power spectral density level to increase from −60 dB to 0 dB) but may be lower to 0.2 ms.

The magnitude squared coherence estimate is a function of frequency with values between 0 and 1 that indicates how well x corresponds to y at each frequency. With regards to the present invention, the signals x and y correspond to the signals from a first and second microphone.

The term phase angle refers to the angular component of the polar coordinate representation, it is synonymous with the term “phase”, and as shown in step 208 can be calculated by the arctangent of the ratio of the imaginary component of the coherence to the real component of the coherence, as is well known. The reference phase angles can be selected based on a desired angle of incidence, where the angle can be selected using a polar plot representation on a GUI. For instance, the user can select the reference phase angle to direct the microphone array sensitivity.

At step 208 the phase angle is calculated; a measured frequency dependent phase angle of the complex coherence is determined. The phase vector from this phase angle can be optionally unwrapped, i.e. not bounded between −pi and +pi, but in practice this step does not affect the quality of the process. The phase angle of the complex coherence is unwrapped to produce an unwrapped phase angle, and the measured frequency dependent phase angle can be replaced with the unwrapped phase angle.

Step 210 is a comparison step where the measured phase angle vector is compared with a reference (or “target”) phase angle vector stored on computer readable memory 212. More specifically, the measured frequency dependent phase angle is compared with a reference phase angle threshold and determining if the measured frequency dependent phase angle exceeds a predetermined threshold from the reference phase angle

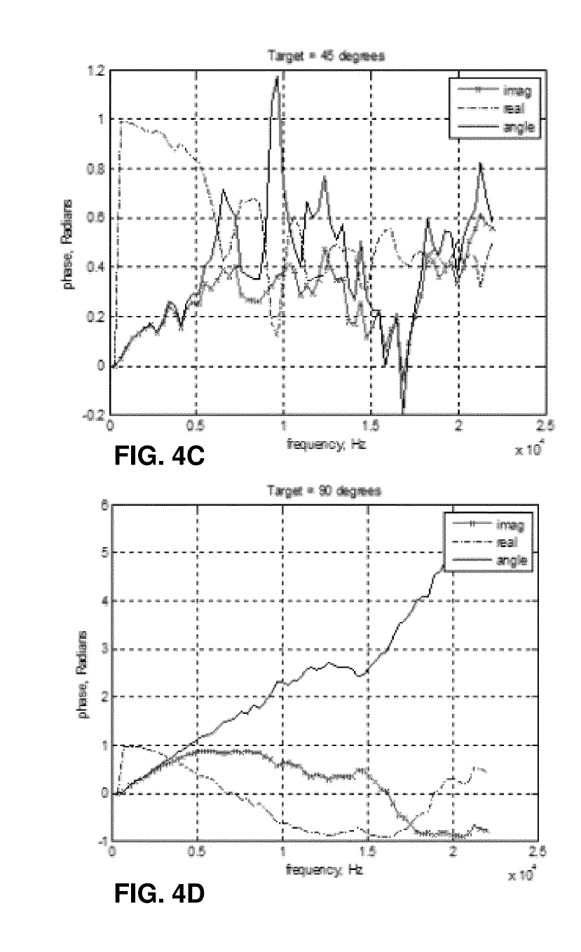

An exemplary process of acquiring the reference phase angle is described in FIG. 3, but for now it is sufficient to know that the measured and reference phase angles are frequency dependent, and are compared on a frequency by frequency basis.

In the most simple comparison case, the comparison 214 is simply a comparison of the relative signed difference between the measured and reference phase angles. In such a simple comparison case, if the measured phase angle is less than the reference angle at a given frequency band, then the update of the adaptive filter in step 216 is such that the frequency band of the filter is increased towards unity. Likewise, if the measured phase angle is greater than the reference angle at a given frequency band, then the update of the adaptive filter in step 216 is such that the frequency band of the filter is decreased towards zero. Namely, the step of updating the set of frequency dependent filter coefficients includes reducing the coefficient values towards zero if the phase angle differs significantly from the reference phase angle, and increasing the coefficient values are increased towards unity if the phase angle substantially matches the reference phase angle.

The reference phase angles can be determined empirically from a calibration measurement process as will be described in FIG. 3, or the reference phase angles can be determined mathematically.

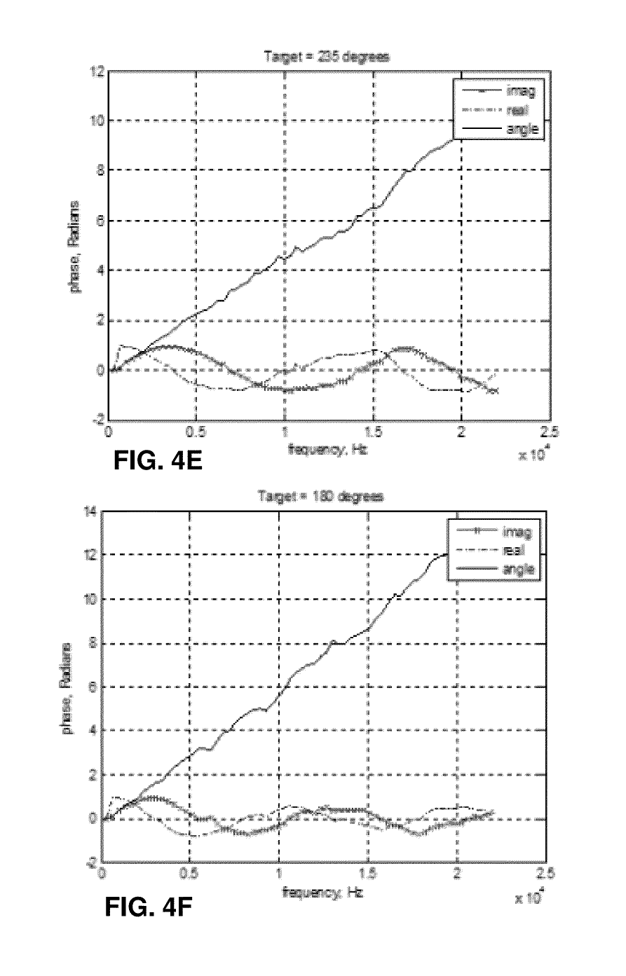

The reference phase angle vector can be selected from a set of reference phase angles, where there is a different reference phase angle vector for a corresponding desired direction of sensitivity (angle theta, 306, in FIG. 3). For instance if the desired direction of sensitivity is zero degrees relative to the 2 microphones then one reference phase angle vector may be used, but if the desired direction of sensitivity is 90 degrees relative to the 2 microphones then a second reference phase angle vector is used. An example set of reference phase angles is shown in FIG. 4.

In step 218, the updated filter coefficients from step 216 are then used to filter the first, second, or a combination of the first and second microphone signals, for instance using a frequency-domain filtering algorithm such as the overlap add algorithm. That is, the first microphone signal or the second microphone signal can be filtered with the updated filter coefficient set to enhance quality of the microphone signal.

FIG. 3 depicts a measurement setup for acquiring target inter-microphone coherence between omni-directional microphones M1 and M2 for sound targets at particular angles of incident. It illustrates a measurement configuration 300 for depicting an exemplary method from obtaining empirical reference phase angle vectors for a desired direction of sensitivity (angle theta, 306).

A test audio signal 302, e.g. a white noise audio sample, is reproduced from a loudspeaker 304 at an angle of incidence 306 relative to the first and second microphones M1 308 and M2 310.

For a given angle of incidence theta, the phase angle of the inter microphone coherence is analyzed according to the method described previously using audio analysis system 312. Notably, the reference phase angles can be obtained by empirical measurement of a two microphone system in response to a close target sound source at a determined relative angle of incidence to the microphones.

FIG. 4A-4F shows an analysis of the coherence from measurement set-up in FIG. 3 with different angle of incidence directions. The plots show the inter-microphone coherence in terms of the imaginary, real, and unwrapped polar angle.

Notice that there is a clear trend in the coherence angle gradient as a function of the angle of incidence. This angle gradient is similar to the group delay of a signal spectrum, and can be used as a target criteria to update the filter, as previously described.

From these analysis graphs in FIG. 3, we can see a limitation with using an existing method described in application WO2012078670A1. That application proposes a dual-microphone speech enhancement technique that utilizes the coherence function between input signals as a criterion for noise reduction. The method uses an analysis the real and imaginary components of the inter-microphone coherence to estimate the SNR of the signal, and thereby update an adaptive filter, that is in turn used to filter one of the microphone signals. The method in WO2012078670A1 does not make any reference to using the phase angle of the coherence as a means for updating the adaptive filter. It instead uses an analysis of the magnitude of the real component of the coherence. But it can be seen from the graphs that the real and imaginary components of the coherence oscillate as a function of frequency.

It should be noted that the method 200 is not limited to practice only by the earpiece device 900. Examples of electronic devices that incorporate multiple microphones for voice communications and audio recording or analysis, are listed

a. Smart watches.

b. Smart “eye wear” glasses.

c. Remote control units for home entertainment systems.

d. Mobile Phones.

e. Hearing Aids.

f. Steering wheel.

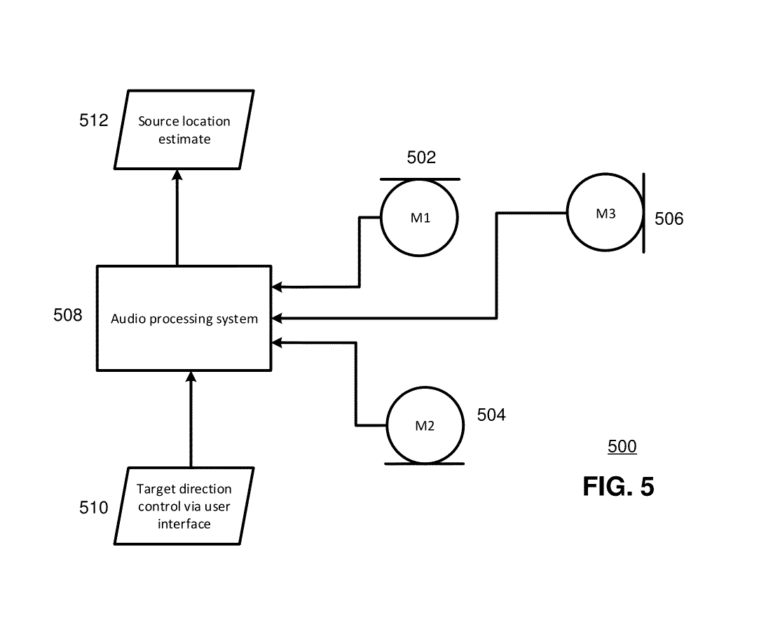

FIG. 5 shows a multi-microphone configuration and control interface to select desired target direction and output source location. The system 500 as illustrated uses three microphones M1 502, M2 504, M3 506 although more can be supported. The three microphones are arranged tangentially (i.e. at vertices of a right-angled triangle), with equal spacing between M1-M3 and M1-M2. Microphones are directed to an audio processing system 508 to process microphone pairs M1-M2 and M1-M3 according to the method described previously. With such a system, the angle theta for the target angle of incidence would be modified by 90 degrees for the M1-M3 system, and the output of the 2 systems can be combined using a summer. Such a system is advantages when the reference angle vectors are ambiguous or “noisy”, for example as with the 45 degree angle of incidence in FIG. 4. In such a case, only the output of the M1-M3 system would be used, which would use a reference angle vector of 90+45=135 degrees.

System 500 also shows how a user interface 510 can select the reference angle vectors that are used. Such a user interface can comprise a polar angle selection, whereby a user can select a target angle by moving a marker around a circle, and the angle of the curser relative to the zero-degree “straight ahead” direction is used to determine the reference angle vector for the corresponding angle of incidence theta, for example a set of reference angles vectors as shown in FIG. 4.

System 500 further shows an optional output 512 that can be used in a configuration whereby the angle of incidence of the target sound source in unknown. The method for determining the angle of incidence is described next.

FIG. 6 depicts a method 600 for determining source location from analysis of measured coherence angle in accordance with an exemplary embodiment. The method 600 may be practiced with more or less than the number of steps shown. When describing the method 600, reference will be made to certain figures for identifying exemplary components that can implement the method steps herein. Moreover, the method 600 can be practiced by the components presented in the figures herein though is not limited to the components shown.

Method 600 describes an exemplary method of determining the angle of incidence of a sound source relative to a two-microphone array, based on an analysis of the angle of the coherence, and associating this angle with a reference angle from a set of coherence-angle vectors. The inter-microphone coherence Cxy and it's phase angle is calculated as previously described in method 600, and reproduced below for continuity.

The first microphone and the second microphone capture a first signal and second signal respectively at step 602 and 604. The order of the capture for which signal arrives first is a function of the sound source location; it not the microphone number; either the first or second microphone may capture the first microphone signal.

At step 606 the system analyzes a coherence between the two microphone signals (M1 and M2). The complex coherence estimate, Cxy as determined in step 206 is a function. At step 608 the phase angle is calculated; a measured frequency dependent phase angle of the complex coherence is determined.

The measured angle is then compared with one angle vector from a set of reference angle vectors 610, and the Mean Square Error (MSE) calculated:

$$MSE ( θ ) = {\sum }_{f = 1}^{N} {( a\_ref ( θ , f ) - a\_m ( f ) )}^{2}$$

Where a_ref(θ,f)=reference coherence angle at frequency f for target angle of incidence θ, and a_m(f)=measured coherence angle at frequency f.

The reference angle vector that yields the lowest MSE is then used to update the filter in step 618 as previously described. The angle of incidence theta for the reference angle vector that yields the lowest MSE is used as an estimate for the angle of incidence of the target sound source, and this angle of incidence is used as a source direction estimate 616.

The source direction estimate can be used to control a device such as a camera to move its focus in the estimated direction of the sound source. The source direction estimate can also be used in security systems, e.g. to detect an intruder that creates a noise in a target direction.

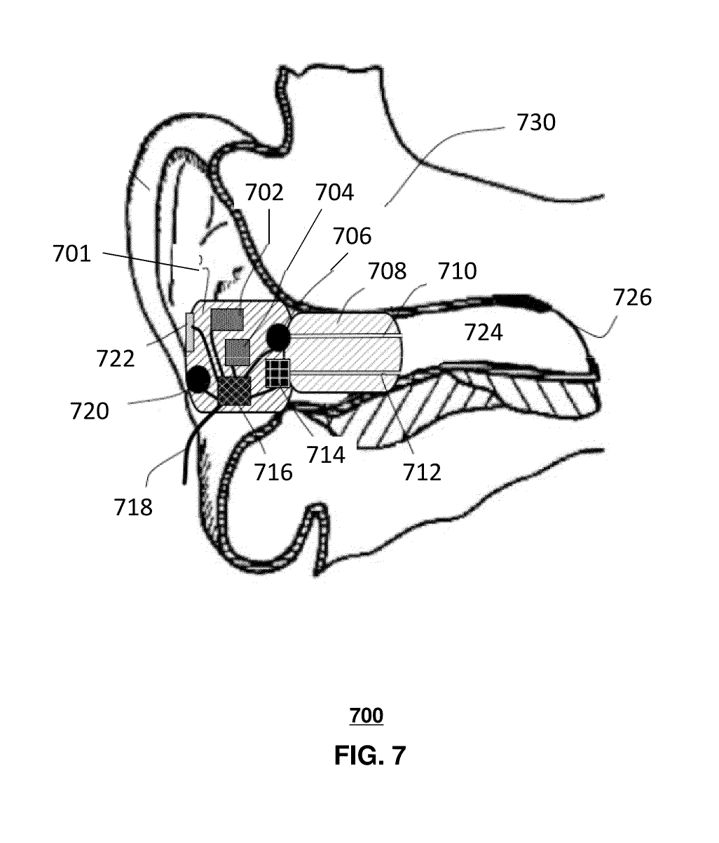

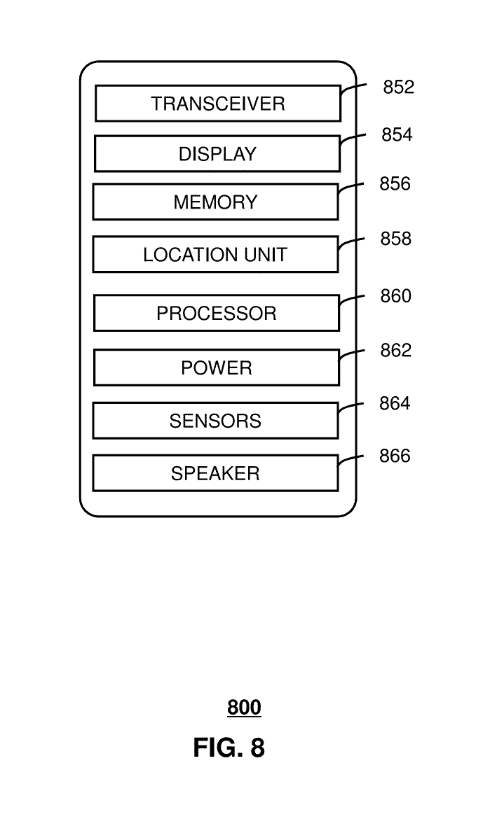

The reader is now directed to the description of FIG. 7 for a detailed view and description of the components of the earpiece 700 (which may be coupled to the aforementioned devices and media device 800 of FIG. 8); components which may be referred to in one implementation for practicing methods 200 and 600. Notably, the aforementioned devices (headset 100, eyeglasses 120, mobile device 140, wrist watch 160, earpiece 500) can also implement the processing steps of method 200 for practicing the novel aspects of directional enhancement of speech signals using small microphone arrays.

As shown in FIG. 7 an exemplary Sound isolating (SI) earphone 700 that is suitable for use with the directional enhancement system 100. Sound isolating earphones and headsets are becoming increasingly popular for music listening and voice communication. SI earphones enable the user to hear and experience an incoming audio content signal (be it speech from a phone call or music audio from a music player) clearly in loud ambient noise environments, by attenuating the level of ambient sound in the user ear-canal. The disadvantage of such SI earphones/headsets is that the user is acoustically detached from their local sound environment, and communication with people in their immediate environment is therefore impaired: i.e. the earphone has a reduced situational awareness due to the acoustic masking properties of the earphone.

Besides acoustic masking, a non Sound Isolating (SI) earphone can reduce the ability of an earphone wearer to hear local sound events as the earphone wearer can be distracted by incoming voice message or reproduced music on the earphones. With reference now to the components of FIG. 7, the ambient sound microphone (ASM) located on an SI or non-SI earphone can be used to increase situation awareness of the earphone wearer by passing the ASM signal to the loudspeaker in the earphone. Such a “sound pass through” utility can be enhanced by processing at least one of the microphone's signals, or a combination of the microphone signals, with a “spatial filter”, i.e. an electronic filter whereby sound originating from one direction (i.e. angle of incidence relative to the microphones) are passed through and sounds from other directions are attenuated. Such a spatial filtering system can increase perceived speech intelligibility by increasing the signal-to-noise ratio (SNR).

FIG. 7 is an illustration of an earpiece device 500 that can be connected to the system 100 of FIG. 1A for performing the inventive aspects herein disclosed. As will be explained ahead, the earpiece 700 contains numerous electronic components, many audio related, each with separate data lines conveying audio data. Briefly referring back to FIG. 1B, the system 100 can include a separate earpiece 700 for both the left and right ear. In such arrangement, there may be anywhere from 8 to 12 data lines, each containing audio, and other control information (e.g., power, ground, signaling, etc.)

As illustrated, the earpiece 700 comprises an electronic housing unit 701 and a sealing unit 708. The earpiece depicts an electro-acoustical assembly for an in-the-ear acoustic assembly, as it would typically be placed in an ear canal 724 of a user. The earpiece can be an in the ear earpiece, behind the ear earpiece, receiver in the ear, partial-fit device, or any other suitable earpiece type. The earpiece can partially or fully occlude ear canal 724, and is suitable for use with users having healthy or abnormal auditory functioning.

The earpiece includes an Ambient Sound Microphone (ASM) 720 to capture ambient sound, an Ear Canal Receiver (ECR) 714 to deliver audio to an ear canal 724, and an Ear Canal Microphone (ECM) 706 to capture and assess a sound exposure level within the ear canal 724. The earpiece can partially or fully occlude the ear canal 724 to provide various degrees of acoustic isolation. In at least one exemplary embodiment, assembly is designed to be inserted into the user's ear canal 724, and to form an acoustic seal with the walls of the ear canal 724 at a location between the entrance to the ear canal 724 and the tympanic membrane (or ear drum). In general, such a seal is typically achieved by means of a soft and compliant housing of sealing unit 708.

Sealing unit 708 is an acoustic barrier having a first side corresponding to ear canal 724 and a second side corresponding to the ambient environment. In at least one exemplary embodiment, sealing unit 708 includes an ear canal microphone tube 710 and an ear canal receiver tube 714. Sealing unit 708 creates a closed cavity of approximately 5 cc between the first side of sealing unit 708 and the tympanic membrane in ear canal 724. As a result of this sealing, the ECR (speaker) 714 is able to generate a full range bass response when reproducing sounds for the user. This seal also serves to significantly reduce the sound pressure level at the user's eardrum resulting from the sound field at the entrance to the ear canal 724. This seal is also a basis for a sound isolating performance of the electro-acoustic assembly.

In at least one exemplary embodiment and in broader context, the second side of sealing unit 708 corresponds to the earpiece, electronic housing unit 700, and ambient sound microphone 720 that is exposed to the ambient environment. Ambient sound microphone 720 receives ambient sound from the ambient environment around the user.

Electronic housing unit 700 houses system components such as a microprocessor 716, memory 704, battery 702, ECM 706, ASM 720, ECR, 714, and user interface 722. Microprocessor 916 (or processor 716) can be a logic circuit, a digital signal processor, controller, or the like for performing calculations and operations for the earpiece. Microprocessor 716 is operatively coupled to memory 704, ECM 706, ASM 720, ECR 714, and user interface 720. A wire 718 provides an external connection to the earpiece. Battery 702 powers the circuits and transducers of the earpiece. Battery 702 can be a rechargeable or replaceable battery.

In at least one exemplary embodiment, electronic housing unit 700 is adjacent to sealing unit 708. Openings in electronic housing unit 700 receive ECM tube 710 and ECR tube 712 to respectively couple to ECM 706 and ECR 714. ECR tube 712 and ECM tube 710 acoustically couple signals to and from ear canal 724. For example, ECR outputs an acoustic signal through ECR tube 712 and into ear canal 724 where it is received by the tympanic membrane of the user of the earpiece. Conversely, ECM 714 receives an acoustic signal present in ear canal 724 though ECM tube 710. All transducers shown can receive or transmit audio signals to a processor 716 that undertakes audio signal processing and provides a transceiver for audio via the wired (wire 718) or a wireless communication path.

FIG. 8 depicts various components of a multimedia device 850 suitable for use for use with, and/or practicing the aspects of the inventive elements disclosed herein, for instance method 200 and method 300, though is not limited to only those methods or components shown. As illustrated, the device 850 comprises a wired and/or wireless transceiver 852, a user interface (UI) display 854, a memory 856, a location unit 858, and a processor 860 for managing operations thereof. The media device 850 can be any intelligent processing platform with Digital signal processing capabilities, application processor, data storage, display, input modality like touch-screen or keypad, microphones, speaker 866, Bluetooth, and connection to the internet via WAN, Wi-Fi, Ethernet or USB. This embodies custom hardware devices, Smartphone, cell phone, mobile device, iPad and iPod like devices, a laptop, a notebook, a tablet, or any other type of portable and mobile communication device. Other devices or systems such as a desktop, automobile electronic dash board, computational monitor, or communications control equipment is also herein contemplated for implementing the methods herein described. A power supply 862 provides energy for electronic components.

In one embodiment where the media device 850 operates in a landline environment, the transceiver 852 can utilize common wire-line access technology to support POTS or VoIP services. In a wireless communications setting, the transceiver 852 can utilize common technologies to support singly or in combination any number of wireless access technologies including without limitation Bluetooth™ Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, EDGE, TDMA/EDGE, and EVDO. SDR can be utilized for accessing a public or private communication spectrum according to any number of communication protocols that can be dynamically downloaded over-the-air to the communication device. It should be noted also that next generation wireless access technologies can be applied to the present disclosure.

The power supply 862 can utilize common power management technologies such as power from USB, replaceable batteries, supply regulation technologies, and charging system technologies for supplying energy to the components of the communication device and to facilitate portable applications. In stationary applications, the power supply 862 can be modified so as to extract energy from a common wall outlet and thereby supply DC power to the components of the communication device 850.

The location unit 858 can utilize common technology such as a GPS (Global Positioning System) receiver that can intercept satellite signals and there from determine a location fix of the portable device 850.

The controller processor 860 can utilize computing technologies such as a microprocessor and/or digital signal processor (DSP) with associated storage memory such a Flash, ROM, RAM, SRAM, DRAM or other like technologies for controlling operations of the aforementioned components of the communication device.

Referring to FIG. 9, a method 900 for deployment of directional enhancement of acoustic signals within social media is presented. Social media refers to interaction among people in which they create, share, and/or exchange information and ideas in virtual communities and networks and allow the creation and exchange of user-generated content. Social media leverages mobile and web-based technologies to create highly interactive platforms through which individuals and communities share, co-create, discuss, and modify user-generated content. In its present state, social media is considered exclusive in that it does not adequately allow others the transfer of information from one to another, and there is disparity of information available, including issues with trustworthiness and reliability of information presented, concentration, ownership of media content, and the meaning of interactions created by social media.

By way of method 900, social media is personalized based on acoustic interactions through user's voices and environmental sounds in their vicinity providing positive effects allowing individuals to express themselves and form friendships in a socially recognized manner. The method 900 can be practiced by any one, or combination of, the devices and components expressed herein. The system 900 also include methods that can be realized in software or hardware by any of the devices or components disclosed herein and also coupled to other devices and systems, for example, those shown in FIGS. 1A-1E, FIG. 3, FIGS. 6-8. The method 900 is not limited to the order of steps shown in FIG. 9, and may be practiced in a different order, and include additional steps herein contemplated.

For exemplary purposes, the method 900 can start in a state where a user of a mobile device is in a social setting and surrounded by other people, of which some may also have mobile devices (e.g., smartphone, laptop, internet device, etc) and others which do not. Some of these users may have active network (wi-fi, internet, cloud, etc) connections and others may be active on data and voice networks (cellular, packet data, wireless). Others may be interconnected over short range communication protocols (e.g., IEEE, Bluetooth, wi-fi, etc.) or not. Understandably, other social contexts are possible, for example, where a sound monitoring device incorporating the acoustic sensor 170 is positioned in a building or other location where people are present, and for instance, in combination with video monitoring.

At step 902, acoustic sounds are captured from the local environment. The acoustic sounds can include a combination of voice signals from various people talking in the environment, ambient and background sounds, for example, those in a noisy building, office, restaurant, inside or outside, and vehicular or industry sounds, for example, alerting and beeping noises from vehicles or equipment. The acoustic sounds are then processed in accordance with the steps of the directional enhancement algorithm to identify a location and direction of the sound sources at step 904, by which directional information is extracted. For instance, the phase information establishes a direction between two microphones, and a third microphone is used to triangulate based on the projection of the established phase angle. Notably, the MSE as previously described is parameterized to identify localization information related to the magnitude differences between spectral content, for example, between voice signals and background noise. The coherence function which establishes a measurable relationship (determined from thresholds) additionally provides location data.

At step 906, sound patterns are assimilated and then analyzed to identify social context and grouping. The analysis can include voice recognition and sound recognition on the sound patterns. The analysis sorts the conversation topics by group and location. For example, subsets of talkers at a particular direction can be grouped according to location and within context of their environmental setting. During the assimilation phase, other available information may be incorporated. Users may be grouped based on data traffic; for example, upon analysis of shared social information within the local vicinity, for example, a multi-player game. Data traffic is analyzed to determine the social context, for example, based on content and number of messages containing common text, image and voice themes, for example, similar messages about music from a concert the users are attending, or similar pricing feedback on items being purchased by the users in their local vicinity, or based on their purchase history, common internet visited sites, user preferences and so on. With respect to social sound context, certain groups in proximity to loud environmental noise (e.g, machine, radio, car) can be categorized according to speaking level; they will be speaking louder to compensate for the background noise. This information is assimilated with the sound patterns to identify a user context and social setting at step 908. For instance, other talker groups in another direction may be whispering and talking lower. A weighting can be determined to equalize each subset group of talkers and this information can be shared under the grouped social context in the next steps.

At step 910, social information based on the directional components of sound sources and the social context is collected. As previously indicated, the acoustic sound patterns are collected by way of voice recognition and sound recognition systems and forwarded to presence systems to determine if there are available services of interest in the local vicinity to the users based on their conversation, location, history and preferences. At step 912, the sound signals can be enhanced in accordance with the dependent context, for example, place, time and topic. The media can be grouped at step 914 and distributed and shared among the social users. These sound signals can be shared amongst or between groups, either automatically or manually. For example, a first device can display to a user that a nearby group of users is talking about something similar to what the current user is referring (.e.g, a recent concert, the quality of the service, items for sale). The user can select from the display to enhance the other groups acoustic signals, and/or send a request to listen in or join. In another arrangement, service providers providing social context services can register user's to receive from these users their sound streams. This allows the local business, of which the users are within proximity, to hear what the users want or their comments to refine their services.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device or portable device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

For example, the directional enhancement algorithms described herein can be integrated in one or more components of devices or systems described in the following U.S. patent applications, all of which are incorporated by reference in their entirety: U.S. patent application Ser. No. 11/774,965 entitled Personal Audio Assistant docket no. PRS-110-US, filed Jul. 9, 2007 claiming priority to provisional application 60/806,769 filed on Jul. 8, 2006; U.S. patent application Ser. No. 11/942,370 filed 2007 Nov. 19 entitled Method and Device for Personalized Hearing docket no. PRS-117-US; U.S. patent application Ser. No. 12/102,555 filed 2008 Jul. 8 entitled Method and Device for Voice Operated Control docket no. PRS-125-US; U.S. patent application Ser. No. 14/036,198 filed Sep. 25, 2013 entitled Personalized Voice Control docket no. PRS-127US; U.S. patent application Ser. No. 12/165,022 filed Jan. 8, 2009 entitled Method and device for background mitigation docket no. PRS-136US; U.S. patent application Ser. No. 12/555,570 filed 2013-06-13 entitled Method and system for sound monitoring over a network, docket no. PRS-161 US; and U.S. patent application Ser. No. 12/560,074 filed Sep. 15, 2009 entitled Sound Library and Method, docket no. PRS-162US.

This disclosure is intended to cover any and all adaptations or variations of various embodiments. Combinations of the above embodiments, and other embodiments not specifically described herein, will be apparent to those of skill in the art upon reviewing the above description.

These are but a few examples of embodiments and modifications that can be applied to the present disclosure without departing from the scope of the claims stated below. Accordingly, the reader is directed to the claims section for a fuller understanding of the breadth and scope of the present disclosure.

What is claimed is:

1. A method, practiced by way of a processor, to increase a directional sensitivity of a microphone signal comprising the steps of:
capturing a first and a second microphone signal communicatively coupled to a first microphone and a second microphone;
calculating a complex coherence between the first and second microphone signal;
determining a measured frequency dependent phase angle of the complex coherence;
comparing the measured frequency dependent phase angle with a reference phase angle threshold and determining if the measured frequency dependent phase angle exceeds a predetermined threshold from the reference phase angle;
updating a set of frequency dependent filter coefficients based on the comparing to produce an updated filter coefficient set; and
filtering the first microphone signal or the second microphone signal with the updated filter coefficient set.

2. The method of claim 1, where step of updating the set of frequency dependent filter coefficients includes:
reducing the coefficient values towards zero if the phase angle differs significantly from the reference phase angle, and
increasing the coefficient values are increased towards unity if the phase angle substantially matches the reference phase angle.

3. The method of claim 1, further including directing the filtered microphone signal to a secondary device that is one of a mobile device, a phone, an earpiece, a tablet, a laptop, a camera, a wearable accessory, eyewear, or headwear.

4. The method of claim 3, further comprising
communicating directional data with the microphone signal to the secondary device, where the directional data includes at least a direction of a sound source; and
adjusting at least one parameter of the device in view of the directional data, wherein the parameters is directed, but not limited to, focusing or panning a camera of the secondary device to the sound source.

5. The method of claim 4, further comprising performing an image stabilization and maintaining focused centering of the camera responsive to movement of the secondary device.

6. The method of claim 4, further comprising selecting and switching between one or more cameras of the secondary device responsive to detecting from the directional data whether a sound source is in view of the one or more cameras.

7. The method of claim 4, further comprising tracking a direction of a voice identified in the sound source, and from the tracking, adjusting a display parameter of the secondary device to visually follow the sound source.

8. The method of claim 1, further including unwrapping the phase angle of the complex coherence to produce an unwrapped phase angle, and replacing the measured frequency dependent phase angle with the unwrapped phase angle.

9. The method of claim 1, wherein the coherence function is a function of the power spectral densities, Pxx(f) and Pyy(f), of x and y, and the cross power spectral density, Pxy(f), of x and y, as:
$${C}_{xy} ( f ) = \frac{{\vert {P}_{xy} ( f ) \vert}^{2}}{{P}_{xx} ( f ) {P}_{yy} ( f )}$$

10. The method of claim 1, wherein a length of the power spectral densities and cross power spectral density of the coherence function are within 2 to 5 milliseconds.

11. The method of claim 1, wherein a time-smoothing parameter for updating the power spectral densities and cross power spectral density is within 0.2 to 0.5 seconds.

12. The method of claim 1 where the reference phase angles are obtained by empirical measurement of a two microphone system in response to a close target sound source at a determined relative angle of incidence to the microphones.

13. The method of claim 1 where the reference phase angles are selected based on a desired angle of incidence, where the angle can be selected using a polar plot representation on a GUI.

14. The method of claim 1 where the devices to which the output signal of step is directed to at least one of the following: loudspeaker, telecommunications device, audio recording system and automatic speech recognition system.

15. The method of claim 1, further including directing the filtered microphone signal to another device that is one of a mobile device, a phone, an earpiece, a tablet, a laptop, a camera, eyewear, or headwear.

16. An acoustic device to increase a directional sensitivity of a microphone signal comprising:
a first microphone; and
a processor for receiving a first microphone signal from the first microphone and receiving a second microphone signal from a second microphone, the processor performing the steps of:
calculating a complex coherence between the first and second microphone signal;
determining a measured frequency dependent phase angle of the complex coherence;
comparing the measured frequency dependent phase angle with a reference phase angle threshold and determining if the measured frequency dependent phase angle exceeds a predetermined threshold from the reference phase angle;
updating a set of frequency dependent filter coefficients based on the comparing to produce an updated filter coefficient set; and
filtering the first microphone signal or the second microphone signal with the updated filter coefficient set.

17. The acoustic device of claim 16, wherein the second microphone is communicatively coupled to the processor and resides on a secondary device that is one of a mobile device, a phone, an earpiece, a tablet, a laptop, a camera, a wearable accessory, eyewear, or headwear.

18. The acoustic device of claim 16, wherein the processor
communicates directional data with the microphone signal to the secondary device, where the directional data includes at least a direction of a sound source; and
adjusts at least one parameter of the device in view of the directional data.
wherein the processor focuses or pans a camera of the secondary device to the sound source.

19. The acoustic device of claim 16, wherein the processor performs an image stabilization and maintains a focused centering of the camera responsive to movement of the secondary device, and, if more than one camera is present and communicatively coupled thereto, selectively switches between one or more cameras of the secondary device responsive to detecting from the directional data whether a sound source is in view of the one or more cameras.

20. The acoustic device of claim 16, wherein the processor tracks a direction of a voice identified in the sound source, and from the tracking, adjusting a display parameter of the secondary device to visually follow the sound source.
